(19) United States
(12) Patent Application Publication
(10) Pub. No.: US 2014/0142763 A1
(43) Pub. Date: May 22, 2014

(54) HOLD MANAGEMENT IN AN ENVIRONMENTAL CONTROLLER

(71) Applicant: ENERGATE INC., Ottawa (CA)

(72) Inventor: Paul HUTCHINSON, Ottawa (CA)

(73) Assignee: ENERGATE INC., Ottawa (CA)

(21) Appl. No.: 13/683,506

(22) Filed: Nov. 21, 2012

(51) Int. Cl. G05B 13/02

(52) U.S. Cl. CPC G05B 13/02
USPC 700/276

(57) ABSTRACT

A method for hold management in an environmental controller is provided. The controller controls heating ventilation and air conditioning (HVAC) equipment to environmental parameters defined by a user. The controller can follow a program schedule or operate in a schedule-free mode; however various hold events can be defined that override the schedule or schedule-free operation. The hold events can define target parameters to be maintained during the hold event. Multiple hold events can be defined where a priority of the hold events can be utilized to determine which hold event should be implemented, without cancelling the lower hold events.

### TECHNICAL FIELD

The present disclosure relates to environmental controllers for homes and/or buildings and in particular to performing holds management in the environmental controller to maintain one or more parameters.

### BACKGROUND

Environmental control in residential homes is performed by a centrally located environmental controller such as a thermostat. The environmental controller is connected to heating and cooling systems such as radiant heating source such as a boiler, a forced air heating source such as a furnace, air conditioner, ventilator, air cleaner, or what may be collectively called heating ventilation and cooling (HVAC) system. The environmental controller includes a temperature sensing mechanism in order to control the HVAC system to maintain a desired temperature. The parameters of the controller can be manually set to desired settings or follow a schedule program of settings dependent on the particular date and time. At various times a user may wish to initiate a hold on the controller which would override the schedule or default settings for one or more parameters. For example when going on vacation a user may wish to have a lower temperature in the house and will program the thermostat to maintain the lower temperature until the hold is cancelled. However the configuring of a hold setting will override another hold setting, therefore each time a hold is completed previous holds must be re-entered by the user.

Accordingly, systems and methods that enable improved hold management in an environmental controller remain highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of an environmental controller;

FIG. 2 shows a representation of a programming schedule for an environmental controller;

FIG. 3 shows a representation of hold management in an environmental controller;

FIG. 4 shows a method of hold management in an environmental controller;

FIG. 5 shows a method of multiple hold prioritizations in an environmental controller;

FIG. 6 shows representations of an environmental controller display interface for programming a temporary hold in a schedule mode;

FIG. 7 shows representations of an environmental controller display interface for programming permanent hold in a schedule mode;

FIG. 8 shows representations of an environmental controller display interfaces for programming a timed hold in a schedule mode and a schedule-free mode;

FIG. 9 shows representations of an environmental controller display interface for programming a vacation hold in a schedule mode and a schedule-free mode; and

FIG. 10 shows a system representation of an environmental controller.

It will be noted that throughout the appended drawings, like features are identified by like reference numerals.

### DETAILED DESCRIPTION

In accordance with an aspect of the present disclosure there is provided a method of scheduling and hold management in an environmental controller, the method comprising determining a first target parameter to be maintained by the environmental controller during a first hold event; determining a second target parameter to be maintained by the environmental controller during a second hold event, the second hold event superseding the first hold event based upon a respective priority of the first hold event and the second hold event; setting the environmental controller to the second parameter until a condition of the second hold event is completed; and setting the environmental controller to the first parameter after completion of the second hold event.

In accordance with another aspect of the present disclosure there is provided an environmental controller comprising a control interface coupled to one or more heating ventilation and air conditioning (HVAC) systems a processor coupled to the control interface; a memory coupled to the processor containing instructions for: determining a first target parameter to be maintained by the environmental controller by controlling the associated HVAC systems during a first hold event; determining a second target parameter to be maintained by the environmental controller by controlling the associated HVAC systems during a second hold event, the second hold event superseding the first hold event based upon a respective priority of the first hold event and the second hold event; setting the environmental controller to the second parameter until a condition of the second hold event is completed; and setting the environmental controller to the first parameter after completion of the second hold event.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

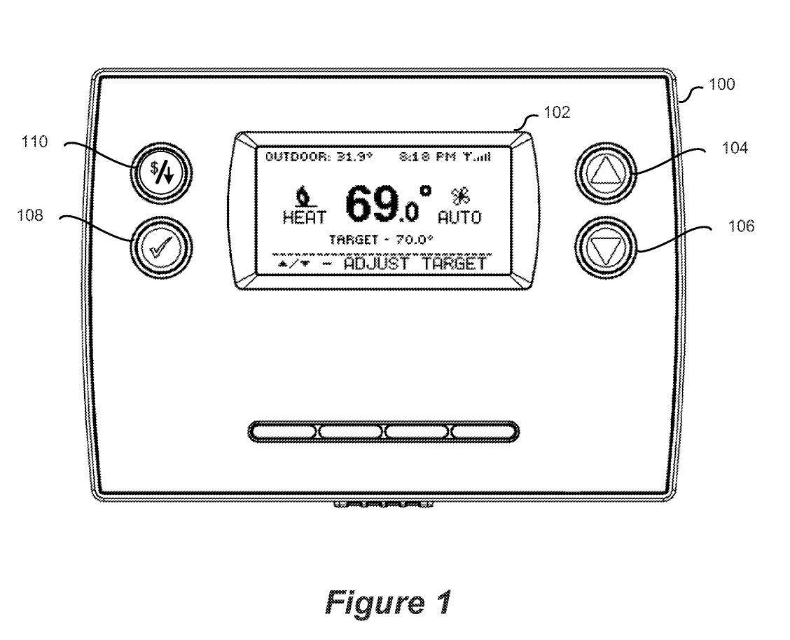

Embodiments are described below, by way of example only, with reference to FIGS. 1-10. FIG. 1 shows a representation of an environmental controller 100. The controller 100 provides temperature control of a building or structure such as a home of office building. The controller 100 interfaces with heating ventilation and air conditioning (HVAC) for controlling associated functions to regulate the environment such as temperature, humidity or air quality within the building. The controller 100 provides a display 102, or may be remotely coupled to a display, providing a user interface for programming the preferences and configuration parameters. The interface may be controlled by directional buttons 104 and 106, with confirmation and cancel buttons 108 and 110 respectively, although other interface configurations such as additional buttons, dials, thumbwheels or sliders may be utilized. Alternatively, a touch interface may be used to program the controller 100. The controller 100 may alternatively be programmed through a remote computing device networked to the controller 100. The environmental parameters such as the current temperature sensed by the controller 100 are displayed. The controller 100 controls the HVAC to meet target parameters such as temperature setpoint. A weekly or daily schedule may be programmed for desired temperatures with the controller 100 performing the control functions to meet the programmed targets. The controller 100 may also provide energy management and control functions to display utility rates, for example cost per kW/Hr, and enable control functions to be programmed relative to the utility rates or demand events. The controller 100 may have a wireless interface to interface with a communication network such as a smartgrid to be controlled remotely or receive information from the utility or weather information sources.

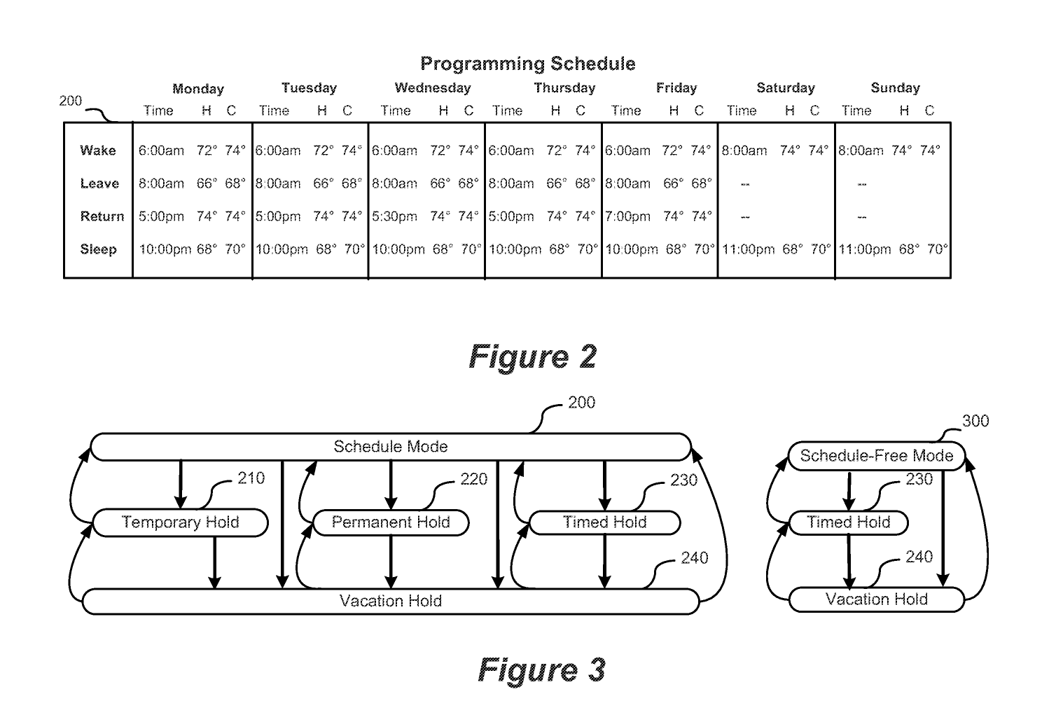

FIG. 2 shows a representation of a programming schedule for a controller 100. The schedule 200 defines time and temperature programming, such as heating and cooling setpoints, to be executed in a set routine by the controller 100. The times and temperatures (° F./° C.) may be defined for a certain number of intervals each day, for example ‘wake’, ‘leave’, ‘return’ and ‘sleep’ or may be configurable to customized intervals. Each day may have the same number of intervals or different intervals and may also define maximum and minimum for various parameters which will typically include heat and/or cooling targets. In a schedule mode the controller 100 will control the environmental equipment to meet the target temperatures according to the schedule. The schedule may also define additional control parameters such as fan operation, humidity levels, zoning functions, electricity or energy supply pricing limits and also define overriding conditions to the schedule. In an alternative programming mode the controller may operate in a schedule-free mode where no intervals are defined and only a target temperature is provided as the default mode of operation. The controller may also be able to be remotely controlled to override current program or setting by a utility in response to energy demand events to adjust the programming schedule. Hold events, also referred to as holds, are traditionally implemented as an exclusive event where a new hold cancels previous holds limiting programming flexibility. The hold events override any scheduled programming either indefinitely or for a defined period of time.

FIG. 3 shows a representation of hold management in a controller 100. Hold events may be defined by the user through the user interface of the controller 100. The controller may also provide hold functions so that the user may program the functions of the controller in a more flexible manner and override a default or programmed setting. The hold events may be defined as temporary 210 where a temperature is maintained until a next programming interval occurs at a particular time, as permanent 220 where a temperature is maintained until the hold is cancelled, as timed 230 where a temperature is maintained for the defined period, or as a vacation hold where the hold start and ends for a defined period. The hold events may not all be accessible or available for programming depending on the operational mode of the controller 100. For example in a schedule mode 200 the temporary hold 210, permanent hold 220, timed hold 230 and vacation hold 240 may be available, where as in a schedule-free mode 300, only the timed hold 230 and vacation hold 240 maybe available. The hold events may be layered to provide prioritization of the holds based upon the respective priority or strength associated with the particular hold event. For example a timed hold 230 maybe set with a vacation hold 240 set on top it. The vacation hold 240 would have the higher priority and would implement on top of the timed hold. When the vacation hold 240 is complete the function will be set to the parameters defined in the timed hold 230 until the desired time period has expired at which the programming would default to the normal mode of operation. For example a timed hold 230 may be set for the next 10 days, where as a vacation hold 240 may supersede the timed hold 230 for 3 days within the 10 day period. After the 10 day period the controller 100 may return to the regular program schedule. In the schedule-free mode 210 of operation, only a timed hold 230 or vacation hold 240 may be provided, the other hold event types may not be provided as a temporary hold which terminates on the next scheduled event or permanent hold which is similar to the schedule-free mode would not provide additional functionality. Although not shown a timed hold 230 could be placed on top of a permanent hold 220 and possibly used in conjunction with a vacation hold 240 providing a multi-layered hold event scenario. Each hold may define a priority which can be on top of a lower holds may be superseded. For example a vacation hold may have the highest priority, followed by a timed hold, then a permanent hold and then a temporary hold having the lowest. Depending on the lowest hold the associated parameter may not be implemented if the priority hold exceeds the programming period of the lower hold. Additional parameters or conditions may be associated with holds, for example demand response events may override a hold, or trigger a hold. Similarly pricing changes may also override a hold or trigger a hold. In addition, each hold may only be associated with a subset of parameters programmable in the controller, where holds that do not define a particular parameter but have priority over a lower hold, would adopt a parameter defined in the lower priority hold.

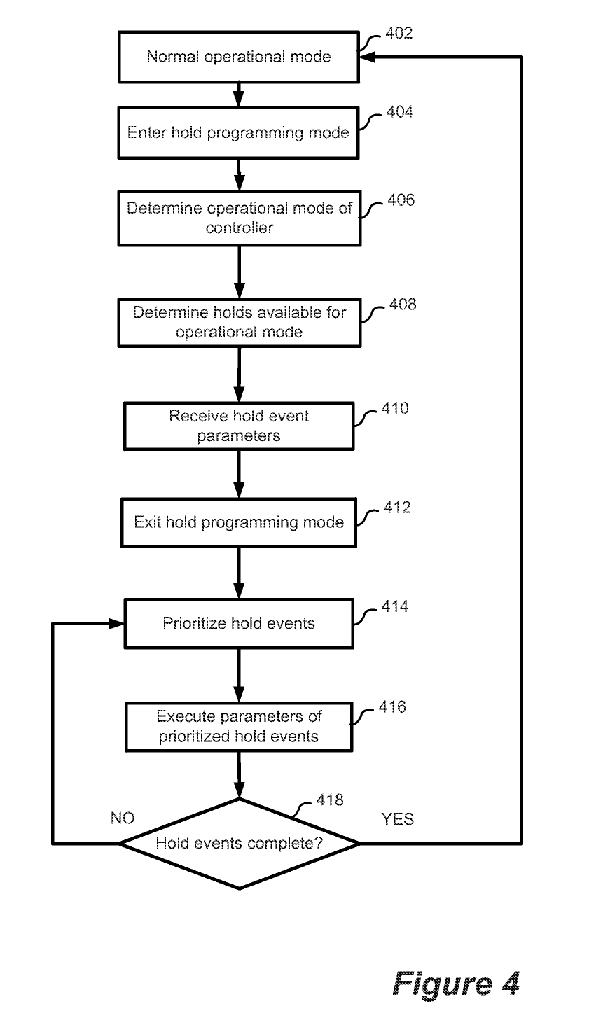

FIG. 4 shows a method of hold management in an environmental controller. The method 400 commences with the controller 100 operating in normal operation (402), either within a schedule or schedule-free mode. When the user selects to enter in a programming mode (404) through the programming interface the operation mode is determined (406) which will determine which holds can be applied (408) or have been previously defined. The appropriate menu can then be presented to the user to enable programming. For example to set new holds, view existing hold(s), cancel one or more hold events. The user can then select a hold event to be programmed and provide the hold parameters (410), for example the desired temperature and length of the hold, if applicable. The hold programming mode is then exited and confirmation that the hold event has been applied can then be presented. If multiple hold events are defined, they can be prioritized (414) and the hold with highest priority can be executed (416). For example a vacation hold event would supersede all other defined hold events. As the hold events complete the other hold events may be executed if they have been defined (NO at 418). If there are no additional holds defined (YES at 418) the operation of the controller 100 reverts to the normal scheduled or schedule-free mode. The hold parameters may also be prioritized relative to other parameters such as utility pricing or demand response events such as a utility requesting a reduction in cooling function by cycling air conditioning loads to help limit energy use at specific peak times and reduce load on the electricity grid. For example, a hold event may also define if a demand response event broadcast can override the hold, or if rates changes such as a price increase or decrease may active a hold event based upon a rate event. Similarly a user may define that is a demand response event is received that further conservation hold could be automatically implemented to further increase conservation beyond the utility requested conservation. In addition some hold events may define more parameters than other hold events, for example a permanent hold may define a humidity level and temperature where as a vacation hold may just define a temperature. The temperature of the vacation hold may take priority over the permanent hold, and the humidity level of the permanent hold may be utilized until both holds are cancelled.

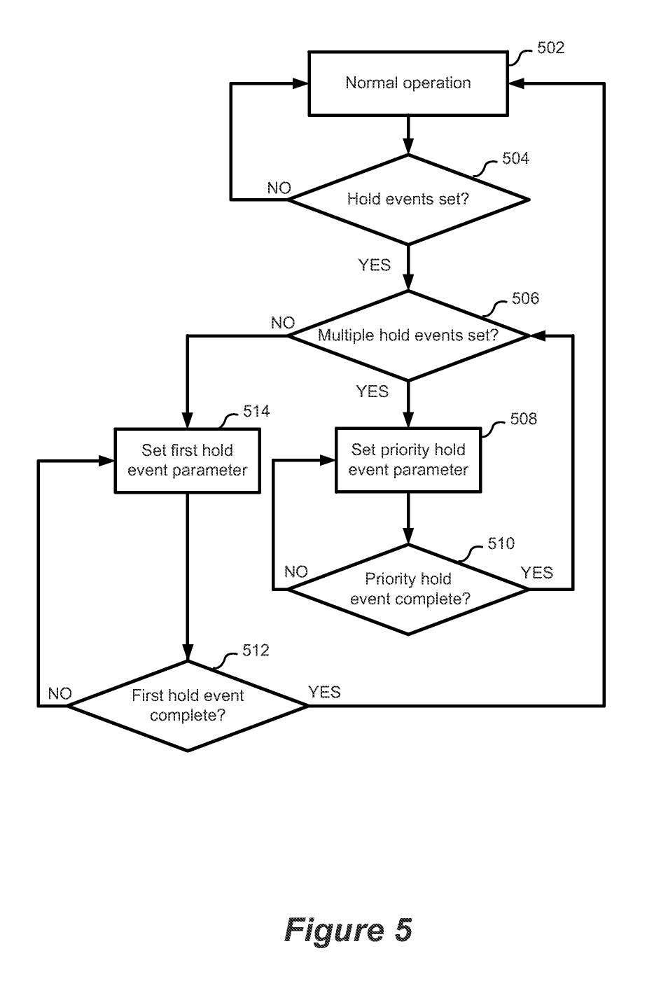

FIG. 5 shows a method of multiple hold event prioritizations in an environmental controller. The method 500 commences with the controller 100 operating in a normal schedule or schedule-free operating mode (502). If a hold event is set (YES at 504) it is determined if more than one hold is set (YES at 506). If only one hold event is set (NO at 506) it is then executed (516). The hold event having the highest priority would then be implemented (508) and the associated parameters, for example a change to the setpoint of a thermostat from 75° F. to 72° F. The priority may be defined based upon the time of the hold event, (temporary, timed, permanent, vacation), the start time associated with the hold event, or a duration of the hold event. The priority hold event is maintained (NO at 510) until a parameter associated with the hold event, such as a period of time, duration, demand response event, external temperature target, or the hold event is manually cancelled by the user. If the hold event is completed, or cancelled, (YES at 510), the method can determine if there are multiple hold defined and if there are (YES at 506) the priorities assessed and implemented (508). If there is not multiple hold events defined, that is there is only one hold event defined (NO at 506) it would then be implemented (514). The primary hold is maintained (NO at 512) until it is completed based upon the associated termination condition being met or the hold cancelled. If the first hold event is completed (YES at 512) the controller 100 returns to the normal operation mode (502) and maintains normal scheduling, or schedule-free, operation until a hold event is set (NO at 504) or triggered based upon the associated condition. The controller allows multiple hold events to be defined enabling hold events to be superseded based upon their relative priority. In contrast to traditional controller management operation where hold events set in a thermostat override previous holds and don't maintain their priority, the ability to layer and prioritize the holds provide improved programming flexibility. It is also contemplated that some of the hold event types may allow multiple hold events to be programmed and not be limited to one hold event type. For example multiple timed hold events or vacation hold events may be simultaneously programmed where the vacation hold events do not overlap. However if they do overlap a priority value associated with the unique vacation events may be utilized. For example a latter vacation hold event may take priority over an earlier vacation hold event.

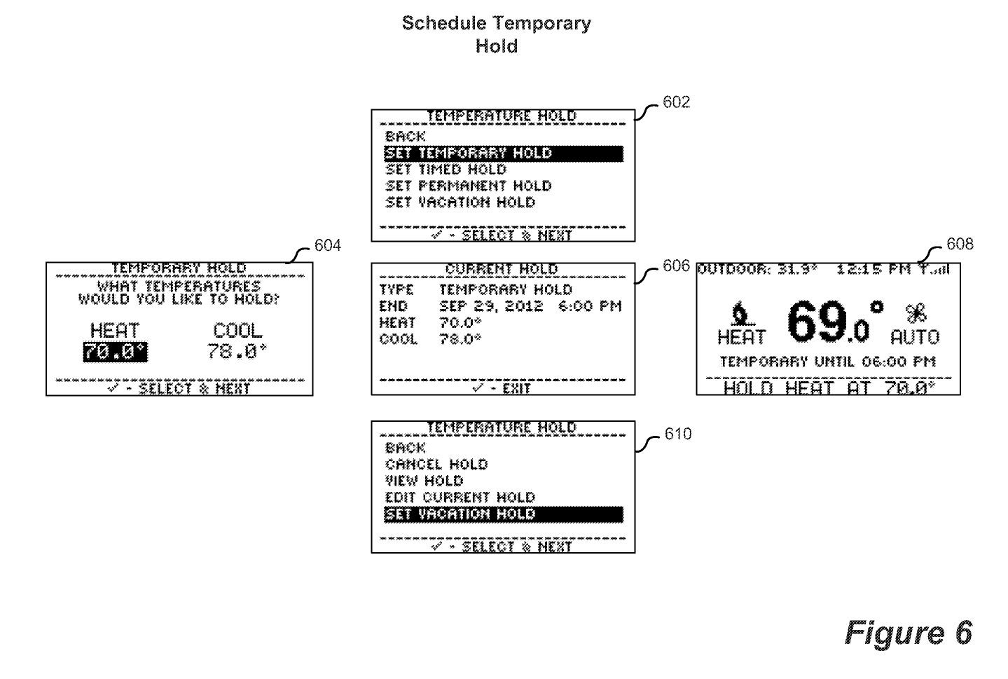

FIG. 6 shows representations of an environmental controller display interface for programming a temporary hold event in a schedule mode. An interface is provided as an illustrative representation of how to set a temporary temperature hold in a controller and is not intended to be limited in the presentation, order, or content of the display interface. When the user enters the programming mode and selects to enter a temperature hold display of the possible holds may be presented 602. A temporary hold is selected and parameter the temperature that the user would like to maintain during the hold event is entered. For each type of hold event the parameters that may be defined may be relative to the operational state of the HVAC system, for example if the controller is set to heat, cool or auto operational states. Although only a heat and cool settings are shown, other parameters may be configured based upon the HVAC equipment controlled by the controller 100, such as humidity, air quality or additional load control functions. The parameters displayed may be presented based upon the HVAC system controlled by the controller 100 or the equipment that is active 604 based upon a preference, seasonal or temperature considerations. Once the setting is provided the hold event settings can be reviewed 606. An operational display screen can be displayed 608 that identifies the current temperature, the type of hold event and the target temperature, however additional information such as utility rates or consumption may also be shown. Subsequent access to the hold menu may be modified to show the additional holds that may be set, such as the vacation hold 610.

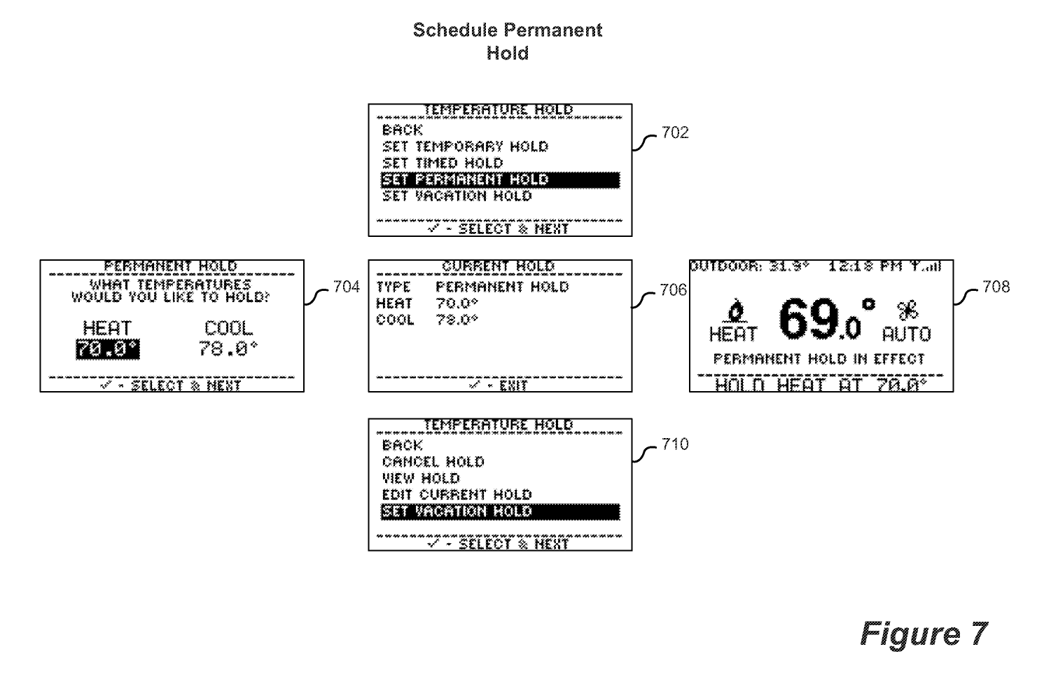

FIG. 7 shows representations of an environmental controller display interface for programming permanent hold event in a schedule mode of a controller 100. An interface is provided as an illustrative representation of how to set a permanent hold in a controller 100 and it not intended to be limited in the presentation or content of the display interface. When the user enters the programming mode and selects to enter a temperature hold event the available hold events may be presented 702. A permanent hold event is selected and a configuration view is provided to define a setpoint for a heat and/or cool setting 704. Once the setting is provided the hold events settings can be reviewed 706. An operational display screen can be displayed 708 that identifies the current temperature, the type of hold and the target temperature. Subsequent access to the hold menu may be modified to show the additional holds that may be set, such as the vacation hold event 710.

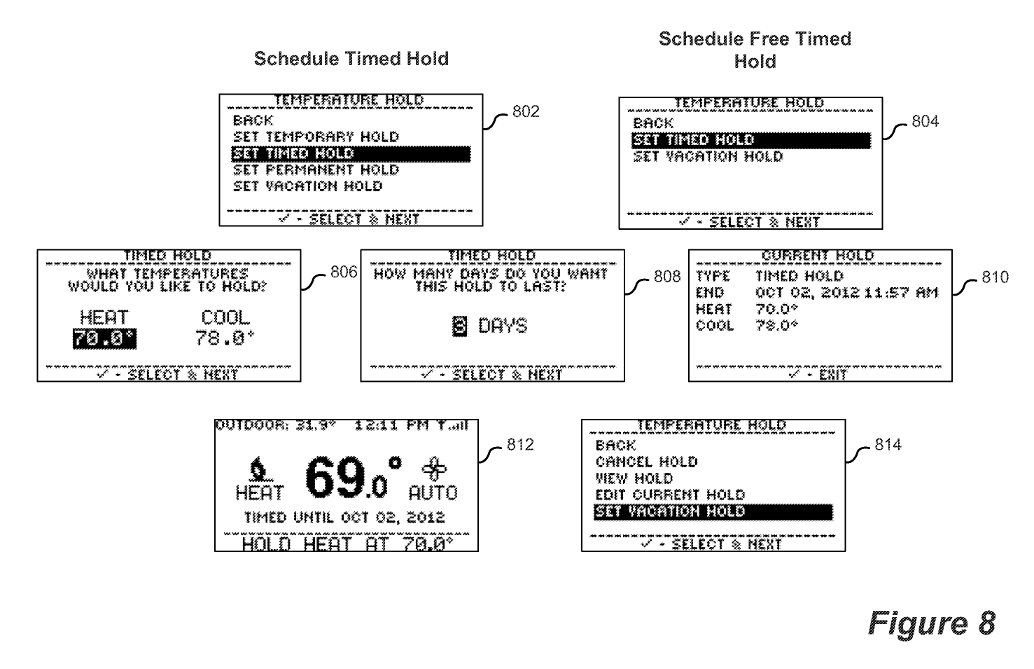

FIG. 8 shows representations of an environmental controller display interface for programming a timed hold event in a schedule mode and a schedule-free mode. An interface is provide as an illustrative representation of how to set a timed temperature hold in a controller and it not intended to be limited in the presentation or content of the display interface. When the user enters the programming mode from a schedule normal operation mode, the available holds are presented 802. If the normal operation mode is a schedule-free mode only subset of available hold events may be presented 804 for programming. A timed hold event is selected and the temperature that the user would like to hold is entered 806. The amount of time such as a number of days may be entered or a target end date provided 808. Once the setting is provided the hold event settings can be reviewed 810. An operation screen can then be displayed 812 that identifies the current temperature, the type of hold and the target temperature. Subsequent access to the hold menu may be modified to show the additional holds that may be set, such as the vacation hold event 814. The timed hold event would then be performed until the defined end date/time occurs.

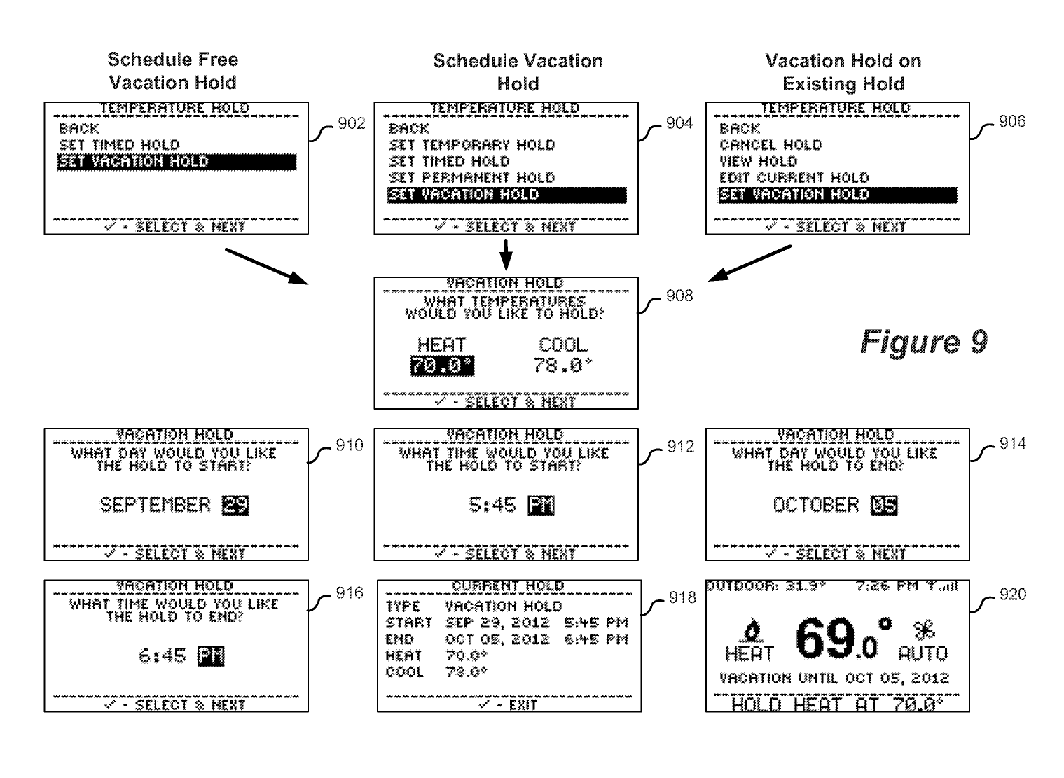

FIG. 9 shows representations of an environmental controller display interface for programming a vacation hold event in a schedule mode and a schedule-free mode. The interface provided to the user in the menu selection may vary based upon the current operating state of the controller. In a schedule-free vacation hold mode the timed and vacation hold options would be presented 902, whereas in a schedule mode all the hold options available may be presented 904. However, if a hold event has been previously configured and an existing hold is defined a modified menu 906 may be presented allowing the viewing of existing hold and defining that additional holds that could be configured. Depending on the configuration additional hold types may be displayed if their priority can be defined. Once the vacation hold is selected the temperature setpoints, or other parameters, can be defined. The start date of the hold can be entered 910 and a start time 912. The end date of the vacation hold 914 can be defined 914 and the end time 916. The hold once confirmed can be reviewed to display the details of the hold 918. An operation screen can be displayed 920 which can identify the current temperature, the type of hold and the target temperature when the vacation hold is executed at the defined start time. During execution of the hold event it may be cancelled or modified.

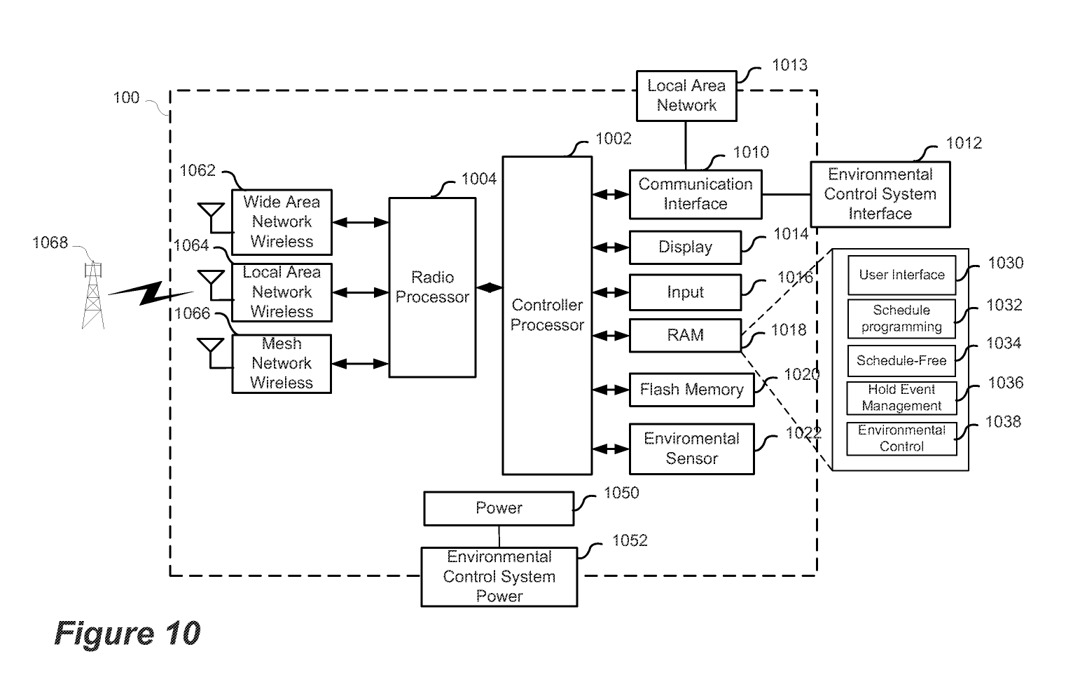

FIG. 10 shows a system representation of an environmental controller. FIG. 10 depicts in a schematic illustrative components of the controller 100. The controller 100 includes a controller processor 1002 that executes instructions to provide the functionality such as environmental control function and a graphical user interface and communicates with HVAC systems. The instructions may be stored in memory such as flash memory 1020 or random access memory (RAM) 1018. The memory executes instructions which provide functionality required to enable user interaction with the controller 100 to program and defined hold events. User interface 1030 displays information related to operation of the HVAC equipment enabling user interaction with the schedule programming function 1032 to be provided. The user may also be able to program a schedule-free 1034 operational mode. Both modes may interact with hold management function 1036 which define the different holds that are available. The schedule and schedule-free functions interface with the environmental control management 1038 which controls the HVAC system functions. Additional features or functions may be provided in the memory. The functions may be updated through a communications network or by local software upload.

The controller processor is also coupled to a display 1014 and an input control 1016 such as input buttons or touch screen interface. The controller 1002 communicates with an environmental sensor 1022 that senses environmental conditions either locally or remotely, such as temperature sensor and/or humidity sensor, connected wired or wirelessly to the controller 100. The controller 100 further comprises a communication interface 1010 that allows the controller 100 to communicate with one or more devices using various types of interfaces such as a remote controller, smartphone, tablet or computer devices. The interfaces may include an environmental control system interface 1012 for communicating with, or controlling, environmental control system components such HVAC equipment using digital or analog control or signalling. A power source 1050 may be provided locally or through a 24 VAC transformer circuit of HVAC equipment, or by other common voltage control interface 1052.

The controller processor 1002 communicates with various components which may include a radio processor 1004. Although the controller 100 is shown as having a radio processor 1004 and controller processor 1002, it should be understood that functions may be combined in a single processor or further divided among discrete components. The wireless communication interfaces may be utilized for interfacing with a smart grid network, smart grid enabled devices, smart devices or load control switches in the home or utilized for sending or receiving information to a remote display unit. The radio interfaces may include a wireless wide area network (WAN) interface 1062, a wireless local area (LAN) network interface 1064 peer-to-peer or bridge connections, a wireless mesh network interface 1066 or other wireless communication interfaces. The wireless communication interfaces may be used to communicate with the environmental devices, sensors or other components either via peer-to-peer, ad-hoc, mesh, or infrastructure wireless networks 1068.

While the disclosure is described in conjunction with specific embodiments, it will be understood that it is not intended to limit the patent disclosure to the described embodiments. On the contrary, it is intended to cover alternative, modifications, and equivalents as may be included within the scope of the disclosure as defined by the appended claims. In the description numerous specific details are set forth in order to provide a thorough understanding of the present patent disclosure. The present disclosure may be practiced without some or all of these specific details. In other instances, well-known process operations have not been described in detail in order not to unnecessarily obscure the present patent disclosure.

1. A method of scheduling and hold management in an environmental controller, the method comprising:
determining a first target parameter to be maintained by the environmental controller during a first hold event;
determining a second target parameter to be maintained by the environmental controller during a second hold event, the second hold event superseding the first hold event based upon a respective priority of the first hold event and the second hold event;
setting the environmental controller to the second parameter until a condition of the second hold event is completed; and
setting the environmental controller to the first parameter after completion of the second hold event.

2. The method of claim 1 wherein the first and second target parameters are temperature setpoints.

3. The method of claim 1 wherein the hold is event completed based upon a date or time.

4. The method of claim 1 wherein the environmental controller is in a schedule operation mode, wherein when the first hold event is completed the environmental controller returns to follow the schedule defining target parameters for one or more time periods.

5. The method of claim 1 wherein the environmental controller is in a schedule-free operation mode, wherein when the first hold event is completed the environmental controller returns to follow the schedule defining target parameters.

6. The method of claim 1 wherein a type of hold event available to be programmed in the environmental controller is based upon the operational mode of the environmental controller.

7. The method of claim 6 wherein if the operational mode of the environmental controller is a schedule mode, wherein the hold events are definable as temporary hold event, timed hold event, permanent hold event, and vacation hold event are available.

8. The method of claim 7 wherein the second hold event is a vacation hold event defining a start date and end date, the vacation hold event having a higher priority than the first hold event.

9. The method of claim 8 wherein the first hold event is one or more of a temporary hold event, time hold event or permanent hold event.

10. The method of claim 6 wherein the operational mode of the environmental controller is a schedule-free mode wherein the hold events are definable as temporary hold event and vacation hold event.

11. The method of claim 1 wherein the priority of the hold event is based upon a hold event type.

12. The method of claim 1 wherein the priority of the hold events are further defined in priority to parameters associated with a utility demand response event.

13. The method of claim 1 wherein the priorities of the hold events are further defined relative to a pricing value.

14. The method of claim 1 wherein the hold events define a parameter to modify existing parameters in a schedule operational mode of the environmental controller while the hold event is set.

15. An environmental controller comprising:
a control interface coupled to one or more heating ventilation and air conditioning (HVAC) systems;
a processor coupled to the control interface;
a memory coupled to the processor containing instructions for:
determining a first target parameter to be maintained by the environmental controller by controlling the associated HVAC systems during a first hold event;
determining a second target parameter to be maintained by the environmental controller by controlling the associated HVAC systems during a second hold event, the second hold event superseding the first hold event based upon a respective priority of the first hold event and the second hold event;
setting the environmental controller to the second parameter until a condition of the second hold event is completed; and
setting the environmental controller to the first parameter after completion of the second hold event.

16. The environmental controller of claim 15 where in the first and second target parameters are temperature setpoints.

17. The environmental controller of claim 15 where in the hold is event completed based upon a date or time.

18. The environmental controller of claim 15 wherein the environmental controller is in a schedule operation mode, wherein when the first hold event is completed the control returns to follow the schedule defining target parameters for one or more time periods.

19. The environmental controller of claim 15 wherein the environmental controller is in a schedule-free operation mode, wherein when the first hold event is completed the control returns to follow the schedule defining target parameters.

20. The environmental controller of claim 15 wherein a type of hold event available in the environmental controller to be displayed to the user is based upon the operational mode of the environmental controller.

21. The environmental controller of claim 20 wherein if the operational mode of the environmental controller is a schedule mode wherein the hold events are definable as temporary hold event, timed hold event, permanent hold event, and vacation hold event are available.

22. The environmental controller of claim 21 wherein the second hold event is a vacation hold event defining a start date and end date.

23. The environmental controller of claim 20 wherein the operational mode of the environmental controller is a schedule-free mode wherein the hold events are definable as temporary hold event and vacation hold event.

24. The environmental controller of claim 15 further comprising a communications interface for receiving utility demand response events wherein the priority of the hold events are further defined relative to a utility demand response event.

25. The environmental controller of claim 15 wherein the priorities of the hold events are further defined relative to a pricing value.
